(19) United States
(12) Patent Application Publication
(10) Pub. No.: US 2007/0102854 A1
(43) Pub. Date: May 10, 2007

(54) Stabilizer for leaf spring suspension device

(76) Inventor: Mark Hellwig, Exeter, CA (US)

Correspondence Address: GREENBERG TRAURIG LLP, 2450 COLORADO AVENUE, SUITE 400E, SANTA MONICA, CA, 90404, US

(21) Appl. No.: 11/270,977

(22) Filed: Nov. 9, 2005

(51) Int. Cl. B60G 11/34

(52) U.S. Cl. 267/27

(57) ABSTRACT

A leaf spring suspension system for a vehicle having spacers between the bottom of the No. 1 spring of the improved leaf spring suspension system and the top of the O.E.M. No. 1 leaf spring of the vehicle. Such spacers apply compression tension to the spring leaves as they contact thus acting as a spreader to keep the mounting hardware constantly in tension and preventing rattling and squeaking of parts. Such a system enhances the roll stability of the vehicle on which the suspension system is mounted.

### BACKGROUND OF THE INVENTION

1. Field of the Invention

The present invention relates generally to vehicle spring suspensions, and, more particularly, to an improved leaf spring suspension device suitable for attachment to vehicle rear suspension springs.

2. Related Art

It is the usual practice to isolate the rear axle of a vehicle from the frame of the vehicle by supporting the axle in a multi-leaf type spring which is suspended between a forward bearing bracket and a rearward spring shackle whereby most imperfections in the road surface can be absorbed by the wheel and the spring construction and not be transmitted to the vehicle passenger compartment through the frame. The multi-leaf type of spring is characterized by a plurality of stacked leafs, usually four or five in number, which decrease in length away from the base or mounting leaf in the form of a truncated triangular configuration. The axle suspension connects to the thickest or highest part of the multi-leaf spring to achieve maximum support.

Occasionally, when a vehicle is utilized to carry especially heavy loads, the existing leaf springs have a tendency to sag or flex sufficiently to wrap-up or permit “bottoming.” Also, upon unusual wear or unusual surface conditions, the existing springs could allow “forward pitch” or “nose dive” of the vehicle, all to the discomfort of the passengers.

In order to enhance the load bearing capabilities of light pickups, trucks, or the like, prior art stabilizing devices have been proposed. Such prior art devices are either made up of a large number of parts, do not adapt easily to preexisting structure or are not totally effective in compensating for heavy loads on the vehicle's suspension system.

In my U.S. Pat. No. 5,992,831, issued Nov. 30, 1999, I disclose a stabilizer for a leaf spring suspension device. U-bolts are used to secure the stabilizing members to the preexisting vehicle multi-leaf member suspension device. Keepers are used on such leaf spring suspension devices to hold the leaves of the multi-leaf spring member. Such U-bolts must not interfere with the keepers holding the multi-leaves together.

In my U.S. Pat. No. 6,158,723, I disclose a U-bolt which can be used to hold a stabilizing spring to the preexisting multi-leaf spring member suspension system of a vehicle without interfering with the keepers retaining the multi-leaves of the multi-leaf spring suspension together.

However, there is a need for taking up the slack and filling in the space between the bottom of the No. 1 leaf spring in these patents and the top of the No. 1 O.E.M. leaf spring. Such a device should be usable with the preexisting U-bolts of such assemblies. By taking up such slack, compression tension is applied to the spring leaves as they contact. This acts as a spreader keeping this group of mounting hardware constantly in tension while preventing rattling and squeaking.

### SUMMARY OF THE INVENTION

It is an object of this invention to provide a leaf spring suspension device that can be quickly and easily mounted to the preexisting leaf spring suspension of a vehicle which provides compression tension to the spring leaves as they contact.

It is a further object of this invention to provide such an improved leaf spring suspension device which has a relatively low number of parts.

It is another object of this invention to provide a soft controlled ride when a vehicle is not loaded and is provided with the suspension device of the invention while preventing rattling and squeaking of parts.

It is a further object of this invention to carrying out the foregoing objects by maintaining the mounting hardware of the leaf spring suspension constantly in tension.

It is still another object of this invention to provide an improved leaf spring suspension system which enhances the roll stability of the vehicle.

These and other objects are preferably accomplished by providing an improved leaf spring suspension system for a vehicle having spacers between the bottom of the No. 1 leaf spring of the improved leaf spring suspension system and the top of the O.E.M. No. 1 leaf spring of the vehicle. Such spacers apply compression tension to the spring leaves as they contact thus acting as a spreader to keep the mounting hardware constantly in tension and preventing rattling and squeaking of the parts. Such an improvement enhances the roll stability of the vehicle on which the suspension system is mounted.

### BRIEF DESCRIPTION OF THE DRAWINGS

FIG. 1 is a perspective view of a conventional multi-leaf type spring having a leaf spring suspension device mounted thereto in accordance with the teachings of the invention;

FIG. 2 is a perspective view of a portion of the assembly of FIG. 1; and

FIG. 3 is a prior art illustration of a portion of a conventional leaf spring prior to mounting the device of the invention thereon.

### DESCRIPTION OF THE PREFERRED EMBODIMENT

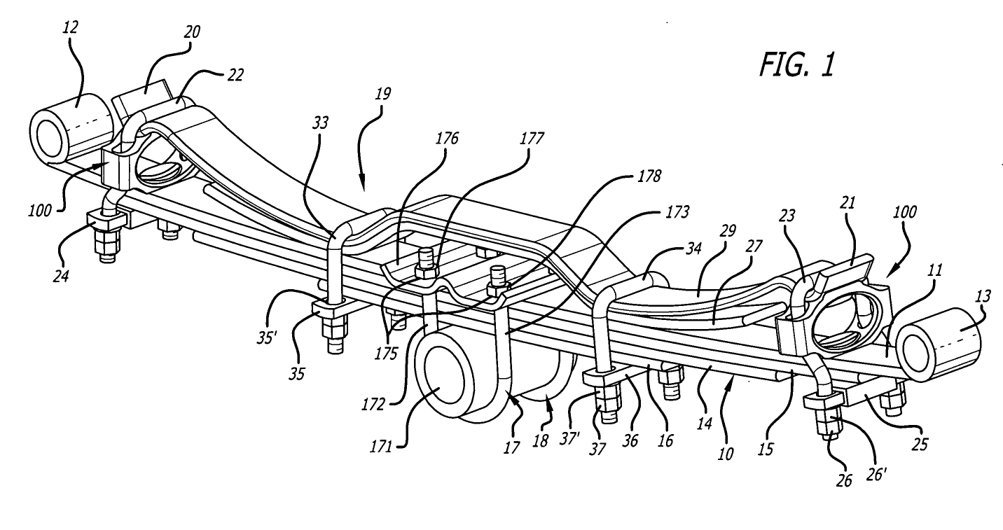

Referring now to FIG. 1 of the drawing, a conventional O.E.M. leaf spring assembly 10 is shown having, extending along a longitudinal direction, an elongated spring member 11 fixed to the vehicle frame (not shown) by means of coiled ends 12, 13 coupled to suitable brackets (not shown) on the vehicle frame. Leaf spring 10, as is well known in the art, is comprised of varying lengths of spring members, such as spring members 14, 15, 16 which are secured to spring member 11 by suitable U-shaped brackets 17, 18 which encircle the vehicle's rear axle 171 as is well known in the art.

Brackets 17, 18 each have interconnected spaced legs 172, 173 extending through holes 175 in mounting bracket 176. The terminal ends of legs 172, 173 are threaded receiving thereon threaded nuts 177, 178, respectively. If desired, spring members 11, 14, 15, 16 may be further secured together at generally the middle thereof by a nut and bolt combination (under bracket 176—not shown).

The foregoing has described original equipment found on vehicles having leaf spring suspension systems. In my U.S. Pat. Nos. 5,922,831 and 6,158,723, the teachings of which are incorporated herein, I described a leaf spring suspension device adapted to be mounted to such a preexisting multi-leaf spring suspension system. Such a system includes, as shown in FIG. 1, a leaf spring suspension device 19 having a spring 29 in the form of an elongated curved length of spring alloy steel or the like bent at opposite ends 20, 21 to provide a gripping portion in which conventional U-shaped threaded bolts 22, 23, respectively, may be disposed. The spaced legs of each bolt 22, 23 are receivable in suitable apertures in brackets 24, 25, respectively, and retained thereto by nuts 26, 26′ threaded to the threaded ends of bolts 22, 23.

Suspension device 19 also includes a curved elongated spring member 27 disposed between spring 29 and multi-leaf spring assembly 10. Although only one such member 27 is shown, obviously more than one may be provided, such as the 2 such spring members 27, 28 in my U.S. Pat. Nos. 5,992,831 and 6,158,723.

Member 27 is of a length less than that of spring 29 which is of a unitary length of a leaf of metallic spring material.

Leaf spring suspension device 19 further includes each member 27, 29 being curved at the middle to form a U-shaped raised portion above the preexisting spring member 11. Members 27, 29 have ends which curve away from member 11 and a pair of threaded U-bolts or brackets 33, 34, couple all members 29, 27, 11, 15, 14 and 16 together. The threaded legs thereof extend through aligned holes 35′ in spaced plates 35, 36 and are secured thereto by nuts 37, 37′. Thus, U-bolts 33, 34, and plates 35, 36 provide bracket means for securing the springs together. Curved member or spring 27 abuts against spring 29 and is slightly less in overall length.

The assembly of parts in FIG. 1 eliminates a number of parts in prior art devices as discussed in my prior patents.

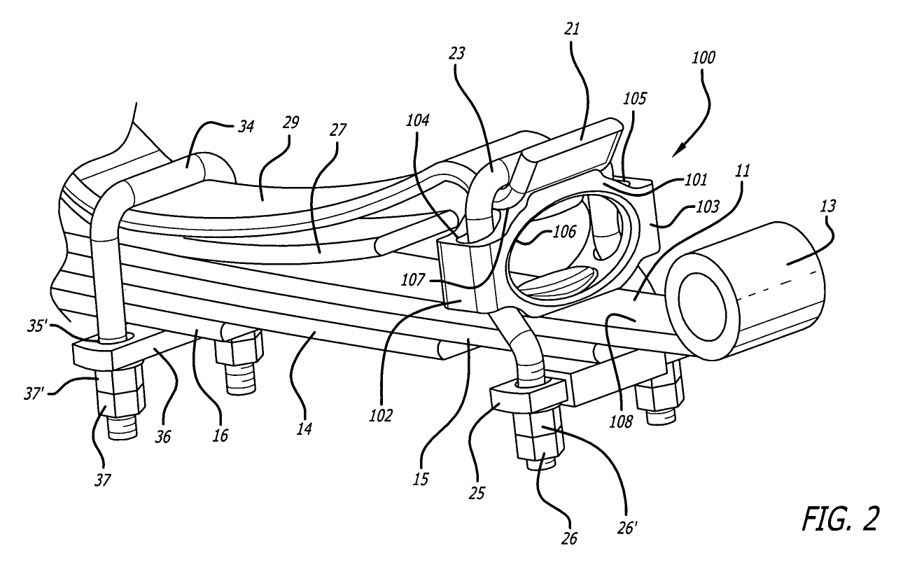

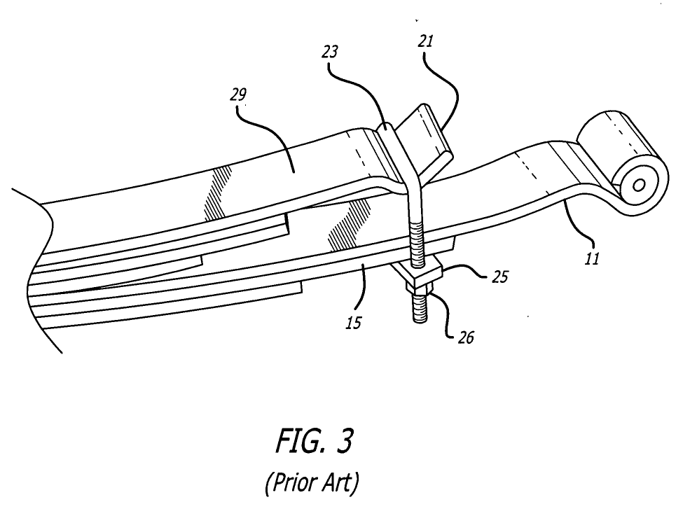

As particularly contemplated in the present invention, and shown more particularly in FIG. 2, a spacer assembly 100 is provided between leaf spring 29 and leaf spring 11. This area is shown in the Prior Art view in FIG. 3 which is a portion of the assembly shown in my U.S. Pat. No. 5,992,831. Here, the upper leaf spring 29 of my prior patent is shown spaced from the O.E.M. leaf spring 11 of the vehicle (not shown). In this view, bracket 23 secures curved end 21 of spring 29 to leaf springs 11 and 15 via bracket 25 and nuts 26. A space is normally present between the bottom of the groove of curved end 21 and the upper surface of spring 11.

Spacer assembly 100 (FIG. 2) fills this space and includes a central main body portion 101 having outwardly extending spaced ends 102, 103 of lesser width then body part 101. A pair of throughbores 104, 105 extend through ends 102, 103, respectively. A large central opening 106 is provided through main body portion 101 having its central axis generally aligned with the elongated axis of spring member 11. As seen in FIG. 2, the spaced legs of bracket 23 extends through holes 104, 105, as shown.

Spacer assembly 100 thus abuts at top against the underside 107 of the groove in curved end 21 of leaf spring 29 and the upper surface 108 of spring 11. Spacer assemblies 100 are provided on each side of the assembly as seen in FIG. 1.

Thus, the spacer assemblies take up the slack between spring 29 and 11 and fill the space between the bottom or underside 107 of the groove in curved end 21 of leaf spring 29 and the top surface 108 of the O.E.M. leaf spring 11. The spacer assemblies 100 are retained in position using the existing nuts, brackets, bolts, etc. of such leaf spring kits.

Although the spacer assemblies can be of any suitable material, one piece polyurethane is preferred. The spacer assemblies 100 apply compression tension to the spring leaves as they contact. The spacer assemblies act as spreaders to keep the mounting hardware constantly in tension and prevent rattling and squeaking. Such spacer assemblies enhance the roll stability of the vehicle by bringing into play the non-O.E.M. springs opposing tension spring rate.

Although a specific embodiment of the invention is disclosed, variations thereof may occur to an artisan and the scope of the invention should only be limited by the scope of the appended claims.

1. In a load assistance device and multi-leaf vehicle spring combination for increasing a vehicle's ability to carry loads by stabilizing the multi-leaf vehicle spring connected to an axle of a vehicle wherein said vehicle includes said multi-leaf vehicle spring extending along a longitudinal direction, a unitary length of metallic spring material connected directly to the multi-leaf vehicle spring at opposite ends thereof forwardly and rearwardly of an axle connection thereof, said length of spring material having a single raised area at generally the midpoint thereof spaced from an uppermost leaf of said multi-leaf vehicle springs, said raised area having a first longitudinal distance, the remainder of said length of spring material having a second longitudinal distance, said first longitudinal distance being a fraction of said second longitudinal distance, said length of metallic spring material extending along the same longitudinal direction as said multi-leaf vehicle spring and adjacent thereto but curved away from said multi-leaf vehicle spring at an angle thereto, at least one spring mounted between said unitary length of spring material and said multi-leaf vehicle spring and extending along the same longitudinal direction of said multi-leaf vehicle spring, at least one spring also having a raised portion conforming to and being adjacent to the raised area of said length of spring material and forming a space between the upper most leaf of the vehicle spring and the lowermost one of said at least one spring when coupled to said multi-leaf vehicle spring, coupling means encircling said unitary length of spring material and said at least one spring and coupling the same to said multi-leaf vehicle spring, the length of spring material being curved at opposite ends forming gripping portions to receive a pair of U-bolts therein for securing said device to said vehicle spring forming a space between the bottom of said curved ends and the upper surface of said vehicle spring, the improvement which comprises:
spacer assemblies of polyurethane material mounted between the bottom of each of said curved ends of said spring material and the upper surface of said vehicle spring, each of said spacer assemblies including a block having a central main body portion with a throughbore having a central axis extending generally parallel to the longitudinal plane of said vehicle spring.

2. (canceled)

3. The combination of claim 1 wherein said block has a pair of apertured ends on opposite sides of said main body portion wherein said apertures extend generally normal to the central axis of said throughbore, said U-bolts having spaced legs extending through said apertures.

4. The combination of claim 3 where said spacer assemblies are of polyurethane.

5. The combination of claim 1 wherein said at least one spring has a length less than said length of spring material.

6. The combination of claim 1 wherein said spacer assemblies comprise cylindrical blocks of said polyurethane material secured to both said length of spring material and said vehicle spring.

7. The combination of claim 6 wherein said blocks have throughbores having central axes generally coincident with the elongated plane of said vehicle spring.

8. The combination of claim 7 wherein said blocks are about 4⅝″ by 3″ and said throughbores are generally oval-shaped.

9. The combination of claim 8 wherein said throughbores have a wide diameter of about 3″ and a narrow diameter of about 1¾″.

10. The combination of claim 1 wherein said spacer assemblies comprise a unitary cylindrical piece of said polyurethane material having said throughbore extending therethrough.
